(19) United States
(12) Patent Application Publication
(10) Pub. No.: US 2004/0258290 A1
(43) Pub. Date: Dec. 23, 2004

(54) Operation console, x-ray fluoroscopic imaging apparatus, and method and system for controlling them

(76) Inventor: Akira Mizukoshi, Tokyo (JP)

Correspondence Address: PATRICK W. RASCHE, ARMSTRONG TEASDALE LLP, ONE METROPOLITAN SQUARE, SUITE 2600, ST. LOUIS, MO, 63102-2740, US

(21) Appl. No.: 10/871,125

(22) Filed: Jun. 18, 2004

(30) Foreign Application Priority Data
Jun. 19, 2003 (JP) 2003-175172

(51) Int. Cl. G06K 9/00

(52) U.S. Cl. 382/130

(57) ABSTRACT

A method and apparatus for controlling pixel values in a region outside a desired region in a captured X-ray fluoroscopic image, a region whose pixel values are to be changed is defined in a fluoroscopic image received from an angiography apparatus, and the amount of change for the pixel values in the defined region is set. The pixel values in the defined region in the fluoroscopic image are then changed based on the set amount of change.

### BACKGROUND OF THE INVENTION

The present invention relates to an X-ray fluoroscopic imaging apparatus and a method of controlling it.

When an angiography apparatus is employed to capture an X-ray fluoroscopic image of an organ of a subject, for example, X-rays passing through a region outside the organ have better permeability than those passing through the organ, and therefore, a portion in the captured X-ray fluoroscopic image outside the organ suffers from halation, i.e., a phenomenon in which the portion dissipates into white in display.

In such a case, a compensation filter is conventionally provided in a collimator for reducing the amount of X-rays emitted from an X-ray tube through the collimator, and the position or angle of the compensation filter is controlled to reduce the amount of X-rays impinging upon the portion outside the organ (for example, see Patent Document 1).

[Patent Document 1]

Japanese Patent Application Laid Open No. 2000-51188

In the conventional technique, it is difficult to modify the characteristics of the compensation filter including its shape and the amount of X-rays to be reduced as desired.

### SUMMARY OF THE INVENTION

Therefore, an object of the present invention is to provide a technique for controlling pixel values in a region outside a desired region in a captured X-ray fluoroscopic image.

To attain the object of the present invention, an operation console in accordance with the present invention has the following configuration, for example.

Specifically, the operation console for receiving from an angiography apparatus for capturing a fluoroscopic image of a subject said fluoroscopic image and processing it, is characterized in comprising: region defining means for defining a region whose pixel values are to be changed in said received fluoroscopic image; change amount setting means for setting the amount of change for the pixel values in the region defined by said region defining means; and pixel value changing means for changing the pixel values in the region defined by said region defining means in said fluoroscopic image based on the amount of change set by said change amount setting means.

To attain the object of the present invention, a system in accordance with the present invention has the following configuration, for example.

Specifically, the system comprised of an angiography apparatus for capturing a fluoroscopic image of a subject and an operation console for receiving said fluoroscopic image from said angiography apparatus and processing it, is characterized in that: said operation console comprises: region defining means for defining a region whose pixel values are to be changed in said received fluoroscopic image; change amount setting means for setting the amount of change for the pixel values in the region defined by said region defining means; and pixel value changing means for changing the pixel values in the region defined by said region defining means in said fluoroscopic image based on the amount of change set by said change amount setting means.

To attain the object of the present invention, a method of controlling an operation console in accordance with the present invention has the following configuration, for example.

Specifically, the method of controlling an operation console for receiving from an angiography apparatus for capturing a fluoroscopic image of a subject said fluoroscopic image and processing it, is characterized in comprising: a region defining step for defining a region whose pixel values are to be changed in said received fluoroscopic image; a change amount setting step for setting the amount of change of the pixel values in the region defined at said region defining step; and a pixel value changing step for changing the pixel values in the region defined at said region defining step in said fluoroscopic image based on the amount of change set at said change amount setting step.

The present invention can control pixel values in a region outside a desired region in a captured X-ray fluoroscopic image.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the configuration of a system in accordance with one embodiment of the present invention.

FIG. 2 is a block diagram showing the basic configuration of an operation console 160.

FIG. 3 is a diagram showing an exemplary display of a GUI for setting a filter.

FIG. 4 is a diagram showing a screen for a GUI for rotating the image of the filter.

FIG. 5 is a diagram of a screen displaying a GUI for moving the position of the image of the filter in the area 301.

FIG. 6 is a diagram of a screen displaying a GUI for changing the size of the image of the filter.

FIG. 7 is a diagram of a screen displaying a GUI for setting the amount of change.

FIG. 8 is a flow chart of filter setting processing.

FIG. 9 is a diagram showing exemplary filter data.

FIG. 10 is a diagram for explaining a method of processing an X-ray fluoroscopic image using the filter data shown in FIG. 9.

### DETAILED DESCRIPTION OF THE INVENTION

The present invention will now be described in detail in terms of preferred embodiments with reference to the accompanying drawings.

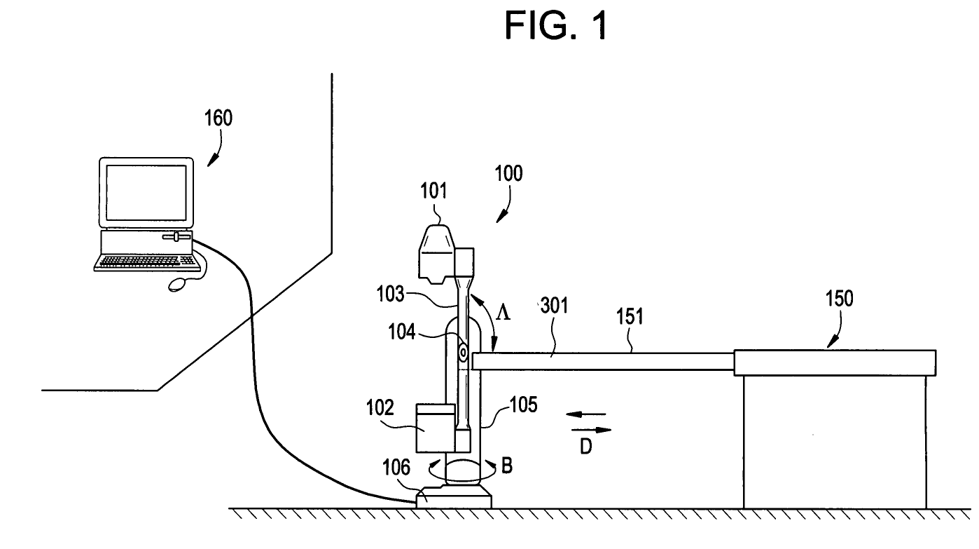

FIG. 1 is a diagram showing the configuration of a system in accordance with the present embodiment. In FIG. 1, reference numeral 100 designates an angiography apparatus, reference numeral 160 designates an operation console, and reference numeral 150 designates a carrier apparatus for laying thereon a subject, and moving the subject up and down and carrying the subject. These apparatuses will be briefly described below.

The angiography apparatus 100 has an X-ray tube 101 for emitting X-rays, and an image intensifier (abbreviated as I. I. hereinbelow) 102 for detecting the X-rays from the X-ray tube 101 as a two-dimensional image, mounted on a generally C-shaped arm 103 facing each other. The central portion of the arm 103 is rotatably attached, as indicated by arrow A, to an axle 104 of a body 105, which is in turn rotatably attached, as indicated by arrow B, to a base 106. In such a configuration, when a subject is positioned between the X-ray tube 101 and I. I. 102, X-rays passing through the subject reach the I. I. 102, and a scanner provided within the I. I. 102 detects a two-dimensional X-ray image (X-ray fluoroscopic image). The detected X-ray fluoroscopic image is displayed on a display screen in a display section, which will be described later, in the operation console 160. Detailed description on the operation console 160 will be made later.

The carrier apparatus 150 comprises a top plate (made of a material having high X-ray transmittance, and reinforced by wrapping a foamed acrylic material or the like in CFRP (carbon fiber reinforced plastic), for example) 151 for laying thereon the subject. The carrier apparatus 150 has a structure for carrying the subject lying on the top plate 151 to between the X-ray tube 101 and I. I. 102 in the angiography apparatus 100, as indicated by arrow D.

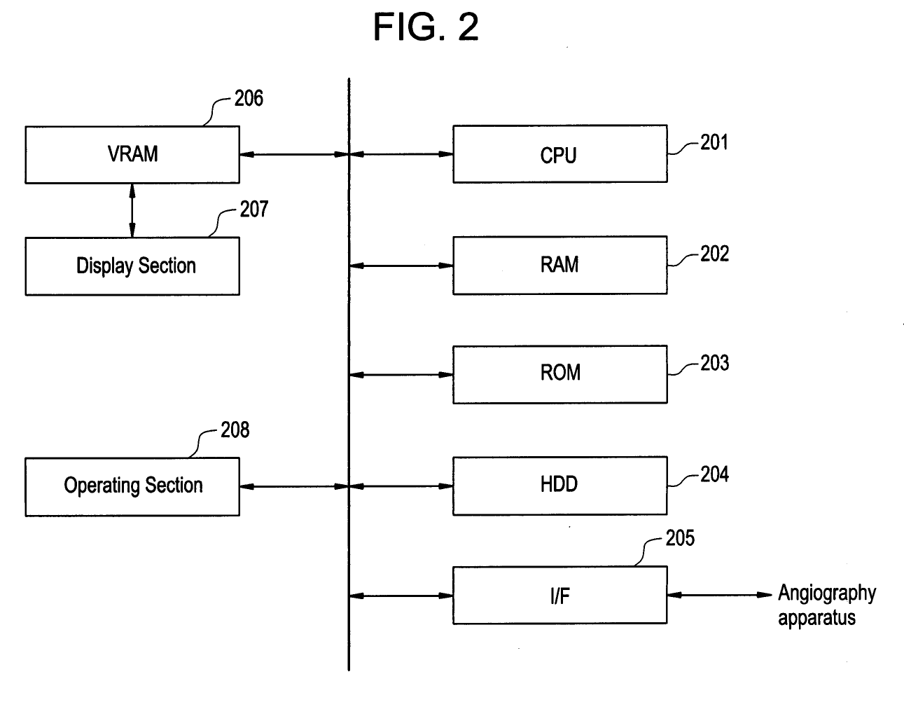

The operation console 160 will now be described. FIG. 2 is a block diagram showing the basic configuration of the operation console 160. The operation console 160 is what is generally called a workstation, and comprises, as shown in FIG. 2, a CPU 201 for controlling the entire apparatus, a ROM 202 for storing a boot program etc., a RAM 203 serving as a main storage device, and the following components.

An HDD 204 is a hard disk device storing an OS, GUI (graphical user interface) programs, which will be described later, and programs for issuing several kinds of instructions to the angiography apparatus 100 and for processing X-ray fluoroscopic images received from the angiography apparatus 100.

An I/F 205 serves as an interface (I/F) for data communication with the angiography apparatus 100, including, for example, transmitting several kinds of instructions to the angiography apparatus 100 and receiving an X-ray fluoroscopic image captured by the angiography apparatus 100.

A VRAM 206 is a memory for developing thereon image data to be displayed, and the image data and the like are developed on the VRAM 206 to enable display of the image data on a display screen in a display section 207. The display section 207 comprises a CRT or liquid crystal display, for example, and is capable of conducting several kinds of display of an X-ray fluoroscopic image received from the angiography apparatus 100, the GUI that will be discussed later, and so forth.

Reference numeral 208 designates an operating section for supplying several kinds of instructions from a human operator to the CPU 201, and the operating section 208 comprises an input device including a keyboard and a mouse.

By such a configuration, the angiography apparatus 100 is capable of sequentially transmitting a captured X-ray fluoroscopic image to the operation console 160, and the operation console 160 is capable of receiving the X-ray fluoroscopic image and displaying it on the display screen in the display section 207.

The X-ray fluoroscopic image normally contains an object to be observed (e.g., an organ), and pixels constituting the object to be observed have appropriate values for satisfactorily viewing the object to be observed in the X-ray fluoroscopic image. The X-ray fluoroscopic image, however, may also contain a region dissipating into white in display outside the region to be observed for the aforementioned reason (which region will be sometimes referred to as a halation region hereinbelow). The pixel values in the halation region are significantly higher than those in the region to be observed, and therefore, change processing for reducing the pixel values in the halation region is necessary.

To address such an issue, in this embodiment, a “filter” is employed to control the pixel values in a desired region in an X-ray fluoroscopic image. At that time, processing for setting the filter is needed. The filter setting processing is conducted before displaying the X-ray fluoroscopic image on the display screen in the display section 207. The setting for the filter will be described below.

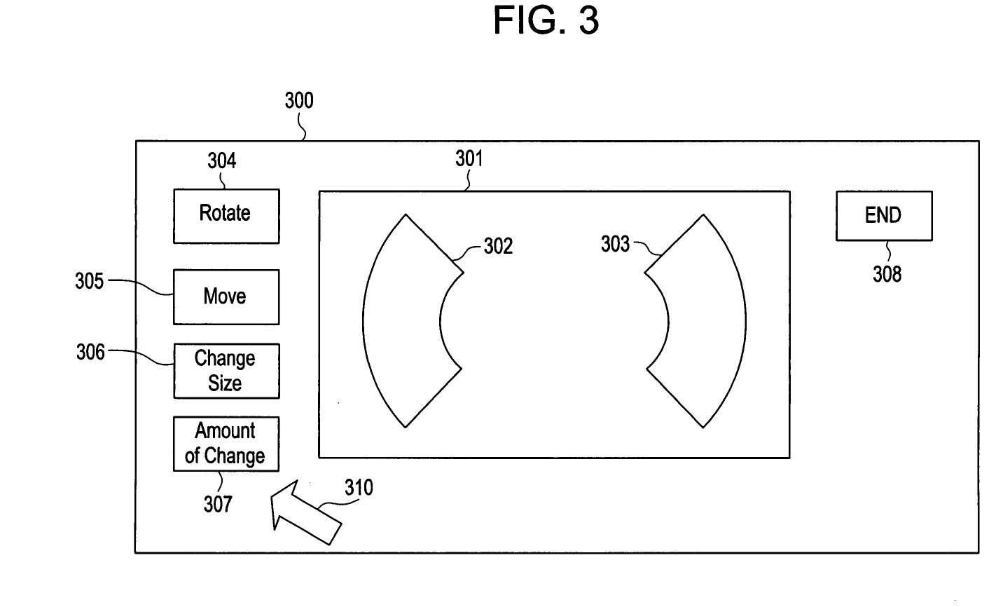

FIG. 3 a diagram showing an exemplary display of a GUI for conducting the setting of the filter. The GUI in FIG. 3 is displayed on the display screen of the display section 207 by loading a program for the GUI from the HDD 204 into the RAM 202, and executing the loaded program by the CPU 201. Moreover, processing executed by operating the GUI is performed by the CPU 201 executing the program.

In FIG. 3, reference numeral 300 designates the whole window for the GUI. Reference numeral 301 designates an area for displaying the filter. In FIG. 3, two filter elements 302 and 303 are displayed in the area 301. The shape of the filter is predetermined here, but data for a filter of another shape may be stored in the HDD 204 for allowing selection.

Although the display form for the filter elements 302 and 303 is not specifically limited, they may be displayed by their contour only, or filled with a predefined color, for example.

In the window 300, five button images 304-308 are additionally displayed.

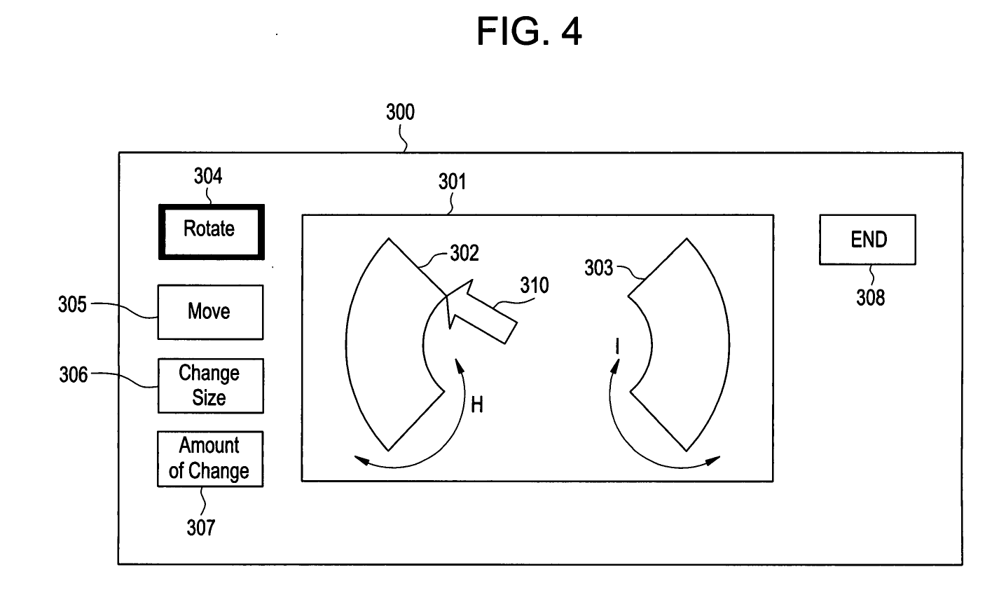

Reference numeral 304 designates a button image for shifting to a mode for rotating the images of the filter elements 302 and 303; when the operator moves a cursor 310 displayed on the screen onto the image 304 using a mouse serving as the operating section 208, and selects the image 304 (e.g., by clicking it), a GUI shown in FIG. 4 is displayed on the display screen of the display section 207. FIG. 4 is a diagram of a screen displaying a GUI for rotating the image of the filter. Portions identical to those in FIG. 3 are designated by the same reference numerals, and explanation thereof will be omitted.

When the operator moves the cursor 310 using the mouse serving as the operating section 208, and selects the image 304 (e.g., by clicking it), the image 304 is highlighted. Although a bold frame is displayed around the image 304 for expressing the highlighting in FIG. 4, the highlighting may be achieved by changing the display color or brightness value for the image 304 as well.

If the image of the filter element 302 is desired to be rotated, for example, the operator moves the cursor 310 onto the image of the filter element 302 using the mouse, and selects the image of the filter element 302 (e.g., by clicking it). Then, when the operator moves the cursor 310 in the direction indicated by H in FIG. 4, the CPU 201 executes processing for rotating the image of the filter element 302 around a predefined position in the filter element 302 by an amount corresponding to the movement amount of the cursor 310. The operator can thus rotate the image of the filter element 302 by a desired amount using the cursor 310.

On the other hand, when the image of the filter element 303 is desired to be rotated, the operator similarly moves the cursor 310 onto the image of the filter element 303 using the mouse, and selects the image of the filter element 303 (e.g., by clicking it). Then, when the operator moves the cursor 310 in the direction indicated by I in FIG. 4, the CPU 201 executes processing for rotating the image of the filter element 303 around a predefined position in the filter element 303 by an amount corresponding to the movement amount of the cursor 310. The operator can thus rotate the image of the filter element 303 by a desired amount using the cursor 310.

By such processing, the gradient of the filter in the area 301 can be set. Although the position of the center for the rotation is predefined here, it may be movable.

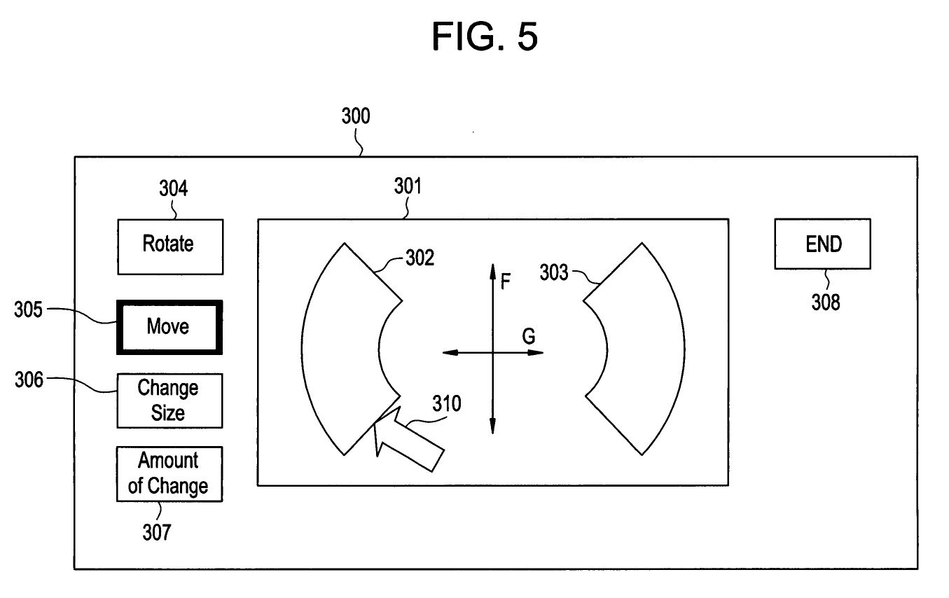

Referring again to FIG. 3, reference numeral 305 designates a button image for shifting to a mode for moving the position of the images of the filter elements 302 and 303 in the area 301; when the operator moves the cursor 310 displayed on the screen onto the image 305 using the mouse serving as the operating section 208, and selects the image 305 (e.g., by clicking it), a GUI shown in FIG. 5 is displayed on the display screen of the display section 207. FIG. 5 is a diagram of a screen displaying a GUI for moving the position of the image of the filter in the area 301. Portions identical to those in FIG. 3 are designated by the same reference numerals, and explanation thereof will be omitted.

When the operator moves the cursor 310 using the mouse serving as the operating section 208, and selects the image 305 (e.g., by clicking it), the image 305 is highlighted. Although a bold frame is displayed around the image 305 for expressing the highlighting in FIG. 5, the highlighting may be achieved by changing the display color or brightness value for the image 305 as well.

If the position of the image of the filter element 302 in the area 301 is desired to be moved, for example, the operator moves the cursor 310 onto the image of the filter element 302 using the mouse, and selects the image of the filter element 302 (e.g., by clicking it). Then, when the operator moves the cursor 310 in a direction indicated by F in FIG. 5, the CPU 201 executes processing for vertically moving the position of the image of the filter element 302 in the area 301 by an amount corresponding to the movement amount of the cursor 310. Likewise, when the operator moves the cursor 310 in a direction indicated by G in FIG. 5, the CPU 201 executes processing for horizontally moving the position of the image of the filter element 302 in the area 301 by an amount corresponding to the movement amount of the cursor 310. The operator can thus move the image of the filter element 302 by a desired amount using the cursor 310.

On the other hand, when the position of the image of the filter element 303 in the area 301 is desired to be moved, the operator similarly moves the cursor 310 onto the image of the filter element 303 using the mouse, and selects the image of the filter element 303 (e.g., by clicking it). Then, when the operator moves the cursor 310 in a direction indicated by F in FIG. 5, the CPU 201 executes processing for vertically moving the position of the image of the filter element 303 in the area 301 by an amount corresponding to the movement amount of the cursor 310. Likewise, when the operator moves the cursor 310 in a direction indicated by G in FIG. 5, the CPU 201 executes processing for horizontally moving the position of the image of the filter element 303 in the area 301 by an amount corresponding to the movement amount of the cursor 310. The operator can thus move the image of the filter element 303 by a desired amount using the cursor 310.

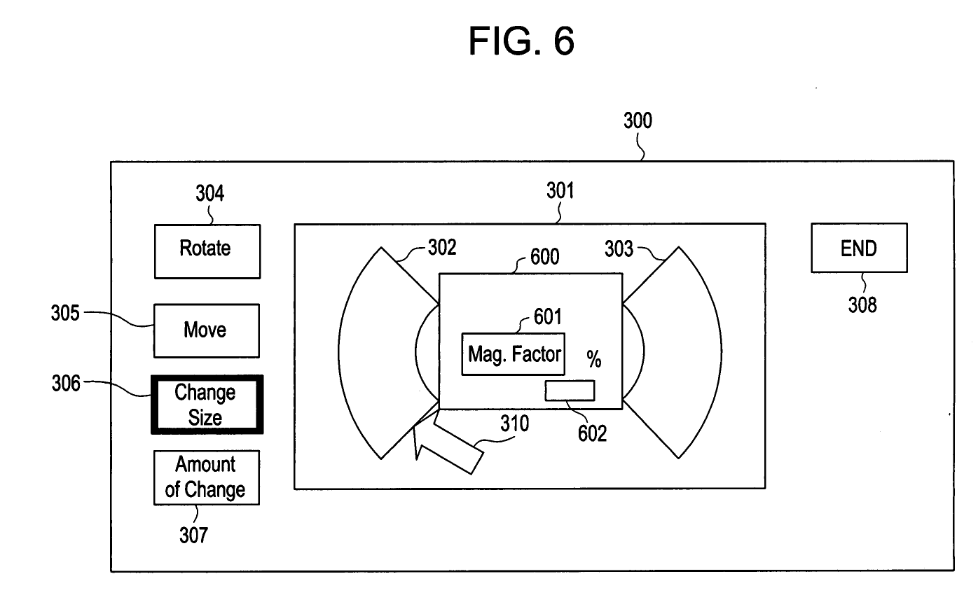

Referring again to FIG. 3, reference numeral 306 designates a button image for shifting to a mode for changing the size of the image of the filter elements 302 and 303; when the operator moves the cursor 310 displayed on the screen onto the image 306 using the mouse serving as the operating section 208, and selects the image 306 (e.g., by clicking it), a GUI shown in FIG. 6 is displayed on the display screen of the display section 207. FIG. 6 is a diagram of a screen displaying a GUI for changing the size of the image of the filter. Portions identical to those in FIG. 3 are designated by the identical reference numerals, and explanation thereof will be omitted.

When the size of the image of the filter element 302 is desired to be changed, for example, the operator moves the cursor 310 onto the image of the filter element 302 using the mouse, and selects the image of the filter element 302 (e.g., by clicking it). The image of the filter element 302 is thus selected as an object whose size is to be changed thereafter.

Next, when the operator selects the image 306 (e.g., by clicking it), the image 306 is highlighted, and at the same time, a window 600 is displayed on the screen. Although a bold frame is displayed around the image 306 for expressing the highlighting in FIG. 6, the highlighting may be achieved by changing the display color or brightness value for the image 306 as well.

The window 600 is provided with a field 601 for inputting a numeric value representing a factor of magnification with respect to the current size (if the magnification factor is less than one, reduction is effected), and when the operator inputs a desired magnification factor using a keyboard serving as the operating section 208, and selects an “OK” button image 602 in the window 600 (e.g., by clicking it) by the cursor 310, the CPU 201 produces an image after magnifying the image of the filter element 302 by the factor input in the field 601, and displays the magnified image on the display screen of the display section 207.

It is obvious that if the operator conducts an operation of initially moving the cursor 310 onto the image of the filter element 363 using the mouse, and selecting the image of the filter element 303 (e.g., by clicking it), the image of the filter element 303 is selected as the object to be magnified.

By the aforementioned operations, the position, size and gradient of the filter elements 302 and 303 in the area 301 are set. In other words, thus defined is a region whose pixel values are to be changed in an X-ray fluoroscopic image when the X-ray fluoroscopic image is displayed in the area 301. Next, setting of the amount of such a change will be described.

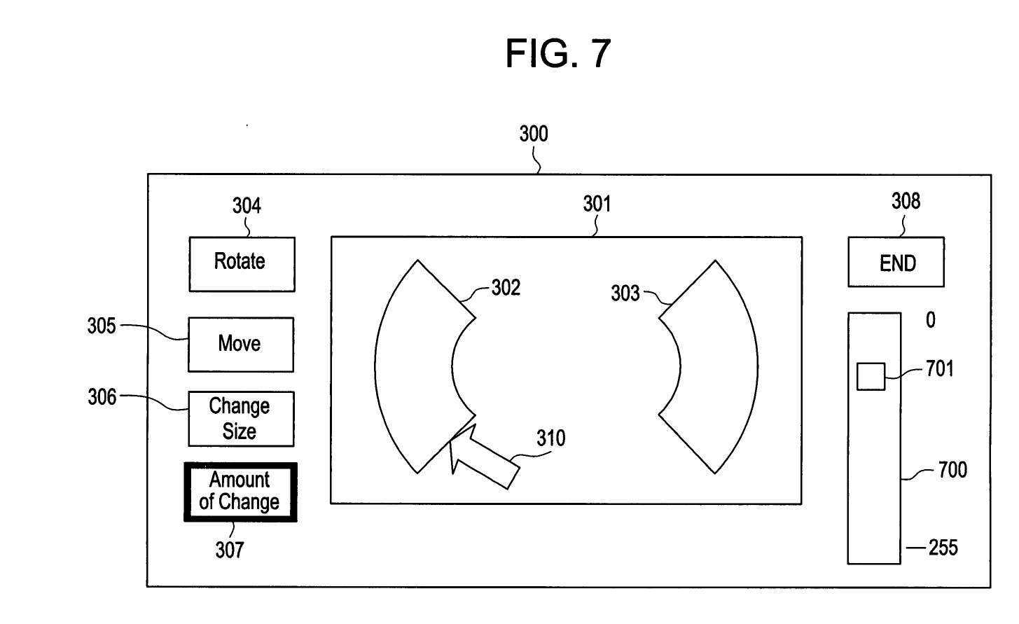

Referring again to FIG. 3, reference numeral 307 designates a button image for shifting to a mode for setting the amount of change representing how much change is effected on pixel values in the region defined by the filter elements 302 and 303; when the operator selects the image 307 (e.g., by clicking it) using the cursor 310 displayed on the screen, a GUI shown in FIG. 7 is displayed on the display screen of the display section 207. FIG. 7 is a diagram showing a screen of a GUI for setting the amount of change. Portions identical to those in FIG. 3 are designated by the identical reference numerals, and explanation thereof will be omitted.

Reference numeral 700 designates a slide bar for indicating the amount of change set for the pixel in either the filter element 302 or 303 where the cursor 310 is positioned. In the present embodiment, pixel values constituting the X-ray fluoroscopic image are represented by eight bits, and accordingly, the slide bar 700 is displayed with numbers from 0-−255. Thus, by vertically moving the button 701 using the cursor 310, the amount of change assigned to the pixels where the cursor 310 is positioned can be changed between 0 and −255.

In this way, the amount of change can be set for the pixels in the filter elements 302 and 303. Moreover, default values considered to be often used may be assigned beforehand to the pixels in the filter elements 302 and 303. Furthermore, by selecting a desired region in the filter by a well known method using the mouse, and vertically moving the button 701 using the cursor 310, the same amount of change may be assigned to all pixels in the selected region.

By the aforementioned processing, a region whose pixel values are to be changed and the amount of change can be specified in the X-ray fluoroscopic image.

Referring again to FIG. 3, when the operator selects an image 308 (e.g., by clicking it) using the cursor 310 displayed on the screen, data representing “a region whose pixel values are to be changed and the amount of change” specified by the aforementioned processing are saved in the HDD 204 as filter data. Specifically, for each pixel in the area 301, if that pixel constitutes a region outside the filter, zero is assigned to the pixel as the amount of change, and if that pixel is in the filter, the set amount of change is assigned to the pixel; and such values are saved in the HDD 204 as a data set in a two-dimensional array.

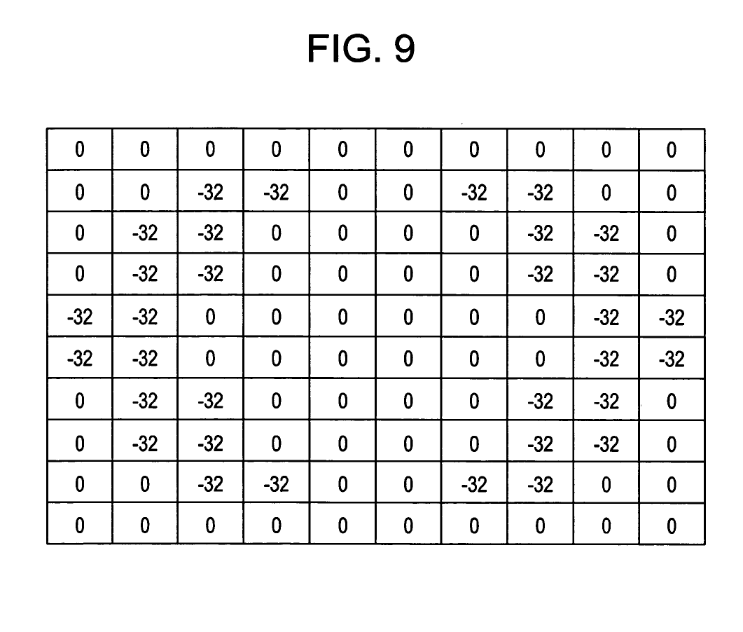

FIG. 9 shows an example of the filter data (a data set in a two-dimensional array) created using the aforementioned GUI's. The data in FIG. 9 are generated by the aforementioned operations on an X-ray fluoroscopic image having ten-pixel columns by ten-pixel rows. In FIG. 9, each box represents a pixel, and a number in a box represents the amount of change set for that pixel.

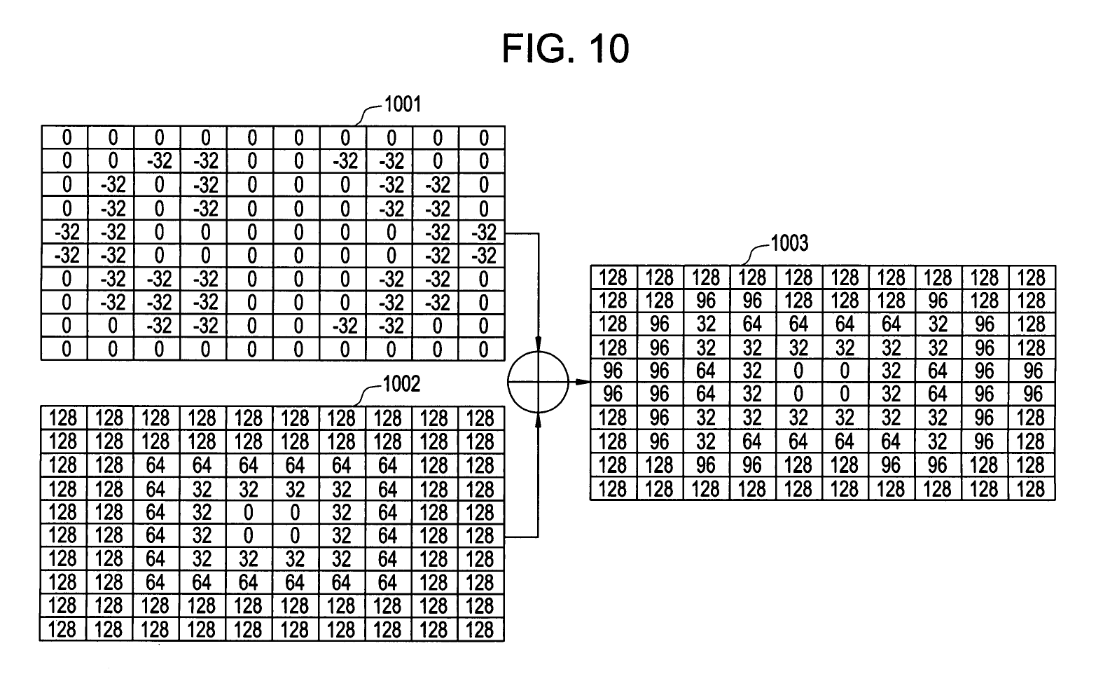

Use of the data shown in FIG. 9 will now be described with reference to FIG. 10. FIG. 10 is a diagram for explaining a method of processing an X-ray fluoroscopic image using the filter data. In FIG. 10, reference numeral 1001 designates the filter data in a two-dimensional data array shown in FIG. 9, and reference numeral 1002 designates an X-ray fluoroscopic image received from the angiography apparatus 100.

The filter data are saved in the HDD 204 as described above, and they are loaded into a first buffer in the RAM 202 in use. Moreover, the X-ray fluoroscopic image received from the angiography apparatus 100 is loaded into a second buffer in the RAM 202.

As shown in FIG. 9, since the amount of change assigned to the pixels constituting the filter is zero or less, addition processing on pixel values between a pixel value constituting the X-ray fluoroscopic image and a positionally corresponding pixel value constituting the filter conducted as shown in FIG. 10 results in a value of each pixel constituting an addition-processed X-ray fluoroscopic image 1003 equal to or reduced as compared with that in the X-ray fluoroscopic image 1001. Moreover, the degree of the reduction can be differentiated corresponding to the amount of change assigned to each pixel in the filter.

Thus, in this embodiment, by assigning a larger amount of change to pixels in a region in the filter corresponding to a halation region in the X-ray fluoroscopic image 1002, i.e., a region of a collection of pixels having values significantly larger than the values of pixels constituting the region to be observed, the pixel values of the pixels constituting the halation region can be significantly reduced after the addition processing.

Moreover, in a region proximate to the halation region and the region to be observed, the amount of change assigned to pixels in the filter corresponding to the proximate region may be one such that the pixel value is smoothly changed from the halation region to the region to be observed.

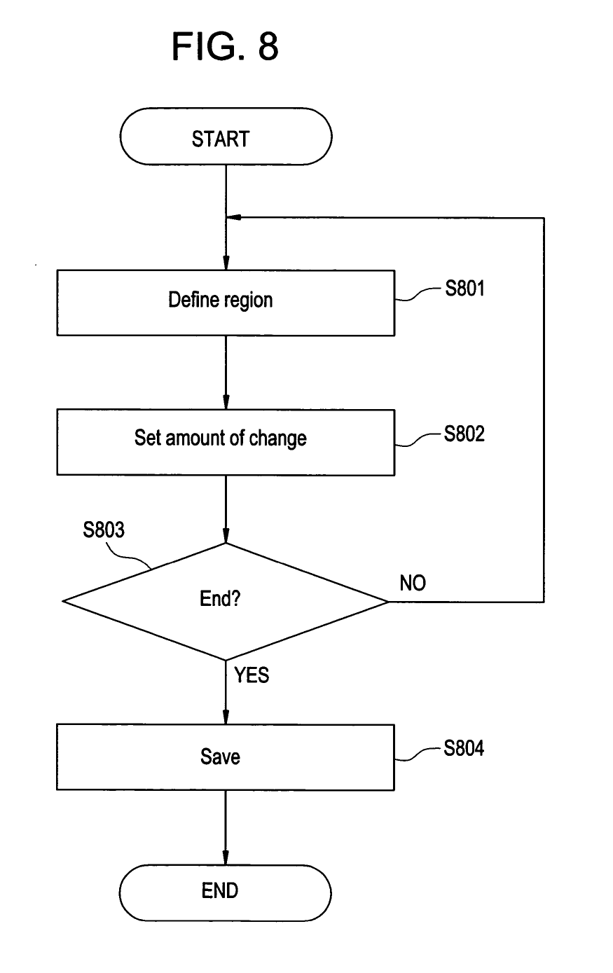

FIG. 8 is a flow chart of the aforementioned filter setting processing. Details of the processing at the steps have been described above, and brief description will be made here. First, a region representing the filter is defined in the area 301 (Step S801). More particularly, the size, gradient and position of the filter are specified. Next, the amount of change is set for the pixels in the filter using the mouse to move the button 701 up and down (Step S802). After the setting has been completed, the END button 308 is selected using the mouse (Step S803) to save the setting in the HDD 204 (Step S804), and the processing is terminated.

It should be noted that the operation scheme and input device used for the scheme in several kinds of settings are provided by way of example in the preceding description, and they are not limited to those disclosed.

Moreover, although the number of filter elements used is two in the preceding description, the number is not limited thereto, and more than two filter elements may be provided, and additionally, the shape of the filter may be edited. Any of these cases can be implemented by changing the pixel values in the two-dimensional data array exemplarily shown in FIG. 9. When a similar operation is conducted by the conventional technique, a more complicated mechanism may be required or the operation itself may be impossible in view of manufacturing considerations; these problems are eliminated by manipulation of the data in the two-dimensional data array according to the present embodiment.

Furthermore, the object of the present invention can also be achieved by providing a system or apparatus with a storage medium (or recording medium) that is recorded with a software program code for implementing the function of the aforementioned embodiment, and reading out and executing the program code stored in the storage medium by a computer (or CPU or MPU) in the system or apparatus. In this case, the program code per se read out from the storage medium implements the function of the aforementioned embodiment, and therefore, the storage medium storing the program code constitutes the present invention. Moreover, not only that the function of the aforementioned embodiment is implemented by executing the read-out program code by the computer (operation console), but the case in which an operating system (OS), for example, running on the computer performs part or all of the actual processing based on instructions by the program code, and the processing implements the function of the aforementioned embodiment, is also included.

When the present invention is applied to such a storage medium, the storage medium is configured to store a program code corresponding to part or all of the aforementioned flow charts (shown in FIG. 8).

Storage media usable for storing such a program code include, for example, a floppy (registered trademark) disk, hard disk, optical disk, magneto-optical disk, CD-ROM, magnetic tape, non-volatile memory card and ROM. Furthermore, such a program code may be downloaded via a medium such as a network (e.g., the Internet).

Many widely different embodiments of the invention may be constructed without departing from the spirit and the scope of the present invention. It should be understood that the present invention is not limited to the specific embodiments described in the specification, except as defined in the appended claims.

1. An operation console for receiving from an angiography apparatus for capturing a fluoroscopic image of a subject said fluoroscopic image and processing it, said operation console comprising:
a region defining device for defining a region whose pixel values are to be changed in said received fluoroscopic image;
a change amount setting device for setting the amount of change for the pixel values in the region defined by said region defining device; and
a pixel value changing device for changing the pixel values in the region defined by said region defining device in said fluoroscopic image based on the amount of change set by said change amount setting device.

2. The operation console of claim 1, wherein said region defining device defines a region whose pixel values are to be reduced in said fluoroscopic image.

3. The operation console of claim 1, wherein said region defining device specifies at least one of the position, gradient and size of said region in said fluoroscopic image.

4. The operation console of claim 1, wherein the region defined by said region defining device is a region of a collection of pixels having pixel values larger by a predefined amount than those in a region as an object to be observed.

5. The operation console of claim 1, further comprising: a display device for displaying the region defined by said region defining device.

6. The operation console of claim 1, wherein said change amount setting device sets the amount of change for reducing the pixel values in the region defined by said region defining device.

7. The operation console of claim 1, further comprising: a storage device for storing data representing the region defined by said region defining device and the amount of change set by said change amount setting device.

8. A system comprised of an angiography apparatus for capturing a fluoroscopic image of a subject and an operation console for receiving said fluoroscopic image from said angiography apparatus and processing it, wherein said operation console comprises:
a region defining device for defining a region whose pixel values are to be changed in said received fluoroscopic image;
a change amount setting device for setting the amount of change for the pixel values in the region defined by said region defining device; and
a pixel value changing device for changing the pixel values in the region defined by said region defining device in said fluoroscopic image based on the amount of change set by said change amount setting device.

9. A method of controlling an operation console for receiving from an angiography apparatus for capturing a fluoroscopic image of a subject said fluoroscopic image and processing it, said method comprising:
a region defining step for defining a region whose pixel values are to be changed in said received fluoroscopic image;
a change amount setting step for setting the amount of change of the pixel values in the region defined at said region defining step; and
a pixel value changing step for changing the pixel values in the region defined at said region defining step in said fluoroscopic image based on the amount of change set at said change amount setting step.

10. The method of controlling an operation console of claim 9, wherein said region defining step comprises defining a region whose pixel values are to be reduced in said fluoroscopic image.

11. The method of controlling an operation console of claim 9, wherein said region defining step comprises specifying at least one of the position, gradient and size of said region in said fluoroscopic image.

12. The method of controlling an operation console of claim 9, wherein the region defined at said region defining step is a region of a collection of pixels having pixel values larger by a predefined amount than those in a region as an object to be observed.

13. The method of controlling an operation console of claim 9, further comprising: a display step for displaying the region defined at said region defining step.

14. The method of controlling an operation console of claim 9, wherein said change amount setting step sets the amount of change for reducing the pixel values in the region defined at said region defining step.

15. The method of controlling an operation console of claim 9, further comprising: a storing step for storing data representing the region defined at said region defining step and the amount of change set at said change amount setting step.
